(19) United States
(12) Patent Application Publication
(10) Pub. No.: US 2018/0283895 A1
(43) Pub. Date: Oct. 4, 2018

(54) NAVIGATION SYSTEM AND METHOD

(71) Applicant: Apple Inc., Cupertino, CA (US)

(72) Inventor: Randol W. Aikin, San Francisco, CA (US)

(21) Appl. No.: 15/762,280

(22) PCT Filed: Sep. 21, 2016
(86) PCT No.: PCT/US2016/052776

§ 371 Date: Mar. 22, 2018

Related U.S. Application Data
(60) Provisional application No. 62/232,141, filed on Sep. 24, 2015.

(51) Int. Cl. G01C 21/36; G01C 21/28; G01C 21/34; G05D 1/02; G05D 1/00

(52) U.S. Cl. CPC G01C 21/3691; G01C 21/28; G05D 1/0088; G05D 1/0276; G01C 21/3492

(57) ABSTRACT

Aspects of the present disclosure involve systems, methods, computer program products, and the like, for altering or generating a navigation path for a vehicle based on aggregated environmental data received from a plurality of vehicles. In one particular implementation, a vehicle may one or more sensors for determining a road condition and/or environmental information around a vehicle. This information may be associated with a geographic location and a timestamp and may be transmitted to a central server or other aggregating device for storage and correlation with other similar information. The information may further be transmitted to a navigation device for use in determining a route from a start point to an end point or adjusting a pre-determined route in response to the route information.

### CROSS REFERENCE TO RELATED APPLICATIONS

This application is related to and claims priority under 35 U.S.C. § 119(e) from U.S. Patent Application No. 62/232,141, filed Sep. 24, 2015, titled “NAVIGATION SYSTEM AND METHOD,” the entire contents of each are incorporated herein by reference for all purposes.

### TECHNICAL FIELD

This disclosure relates generally to generating a route path between two points on a map, and more specifically to determining a route path based on environmental data aggregated from a plurality of data collectors collecting and reporting environmental and road conditions in an area of the route.

### BACKGROUND

Navigation devices provide users of the device with a digital map of a particular location and often also provide turn-by-turn navigation directions from a first point on the map to a destination point on the map. In many such devices, the geographic location of the device is determined utilizing Global Positioning System (GPS) technology. The location of the device is typically illustrated on a screen of the navigation device along with a map of the surrounding area. Further, once a destination location is input to the navigation device, the device may calculate a particular route from the device location to the destination location. As such, a user of the navigation device may obtain a route from the user's location to a destination. Today, navigation devices are typically used in vehicles and/or mobile devices to aid a user of the device to reach a desired destination.

### SUMMARY

One implementation of the present disclosure may take the form of a method for providing navigation information to a vehicle. The method includes the operations of receiving a plurality of environmental data information set from a plurality of vehicles comprising a corresponding plurality of road surface indicators from different geographic locations and associating a subset of the environmental data information set to a particular geographic location. The method further includes the operations of determining an environmental condition at the particular geographic location based at least on the subset of environmental data information set received from the plurality of vehicles and transmitting the environmental condition at the particular geographic location to at least one navigation device.

Another implementation of the present disclosure may take the form of a method for operating a vehicle. The method may include the operations of calculating an initial route for the vehicle from a starting location to a destination location, the initial route comprising at least one road with a surface and receiving an environmental data information set, the environmental data information set comprising at least an indication of an environmental condition of a portion of the initial route and wherein the environmental data information set is derived from a plurality of data collectors at or near the at least one road surface. The method may also include the operations of calculating an alternate route for the vehicle based at least on the received environmental dataset from the server and controlling the vehicle along the alternate route.

Yet another implementation of the present disclosure may take the form of system for providing environmental data to a vehicle. The system may include a processing device in communication with a network and receiving a plurality of environmental datasets from a plurality of vehicles, a subset of the plurality of environmental data information sets comprising at least an indication of an environmental condition at a particular geographic location and a non-transitory database for storing the plurality of environmental data information sets from the plurality of vehicles. When the processing device executes one or more instructions that cause the processing device to perform the operations of associating the subset of the plurality of environmental data information sets from the plurality of vehicles with the particular geographic location, determining an environmental condition at the particular geographic location based at least on the subset of the plurality of environmental data information sets received from the plurality of vehicles, and transmitting the environmental condition at the particular geographic location to at least one navigation device, wherein the navigation device calculates a route from a starting location to a destination location based at least on the transmitted environmental condition at the particular geographic location.

### BRIEF DESCRIPTION OF THE DRAWINGS

FIG. 1 is a diagram of a system for aggregating environmental data from a data collector to determine or adjust a route provided through a navigation device.

FIG. 2 is a flowchart of a method for aggregating environmental data from a plurality of data collectors and providing the aggregated data to one or more navigation devices.

FIG. 3 is a flowchart of a method for determining or adjusting a route in a navigation device based on received environmental data.

FIG. 4 is a diagram of a system for collecting and providing environmental data from one data collector to another data collector for aggregating data for a navigation route.

FIG. 5 is a flowchart of a method for predicting a future traffic pattern from one or more road or environmental conditions.

FIG. 6 is a flowchart of a method for predicting a weather condition from weather data collected from multiple data collectors.

FIG. 7 is a diagram illustrating an example of a computing system which may be used in implementing embodiments of the present disclosure.

FIG. 8 is a functional block diagram of an electronic device including operational units arranged to perform various operations of the presently disclosed technology.

### DETAILED DESCRIPTION

Aspects of the present disclosure involve systems, methods, computer program products, and the like, for altering or generating a navigation path for a vehicle based on aggregated environmental data received from a plurality of vehicles and other sources. In one particular implementation, a vehicle may include one or more sensors for gathering various information including road conditions, hazards on the road, traffic information, and/or environmental information around a vehicle. This information may be associated with a geographic location, a timestamp, route information, and a datestamp. In addition, the information may be transmitted or otherwise provided to a server or other aggregating device for storage and correlation with other similar information. The navigation server may be in communication with and receive information from numerous such vehicles to create a crowd-sourced, real-time map and collection of information of a region that includes current or recent road and environmental conditions accessible by geographic location. In yet another implementation, the various road and environmental information may be gathered by other types of mobile devices that communicate with the navigation server.

In addition, the aggregated, crowd-sourced road, environmental, and other information may be available to a navigation device for reference by the device to understand the condition and any potential hazards of a navigation accessible route. For example, a navigation device may request or otherwise receive the route information stored in the navigation server or may calculate a route using locally stored information. With this information, the navigation device may determine a route from a start point to an end point or adjust a pre-determined route in response to the route information. For example, the navigation device may provide a first route based on the start and stop points provided to the device. While proceeding along the route, the device may receive information from the server indicating that the road surface at some point along the navigation route is wet or snow covered. In response, the navigation device may calculate a new route to avoid wet or snowy road surfaces, to avoid or alert the driver or possibly unsafe driving conditions or to avoid the increased likelihood of slow traffic caused by the road surface conditions. In addition, this new route calculation may include receiving road and environmental information for roads and routes in the near vicinity of the first route to determine the route with more favorable road conditions.

The information aggregated at the navigation server or other device may be collected and provided by any number of vehicles or other data collectors. Other data collector examples include mobile computing devices, such as mobile phone and tablets, or other computing devices configured to perform any of the operations described herein. In addition, such information may be stored at the data collector until the data collector is in communication with the navigation server. For example, in transit, there may be times when the data collector is not able to wirelessly communicate with the navigation server. In such circumstance, the data collector may collect and store the geographic-tagged road and environment conditions until the data collector is in communication again with the navigation server. In another implementation, the data collector may transmit the collected data to another data collector in communication with the navigation server. In this manner, the navigation server may receive updated road and environmental information for a particular geographic location from several data collectors and provide such information to navigation devices for use in route planning In another implementation, the data collectors may store the collected information locally, transmit the stored information with other data collectors, and utilize the information for adjusting or calculating a route.

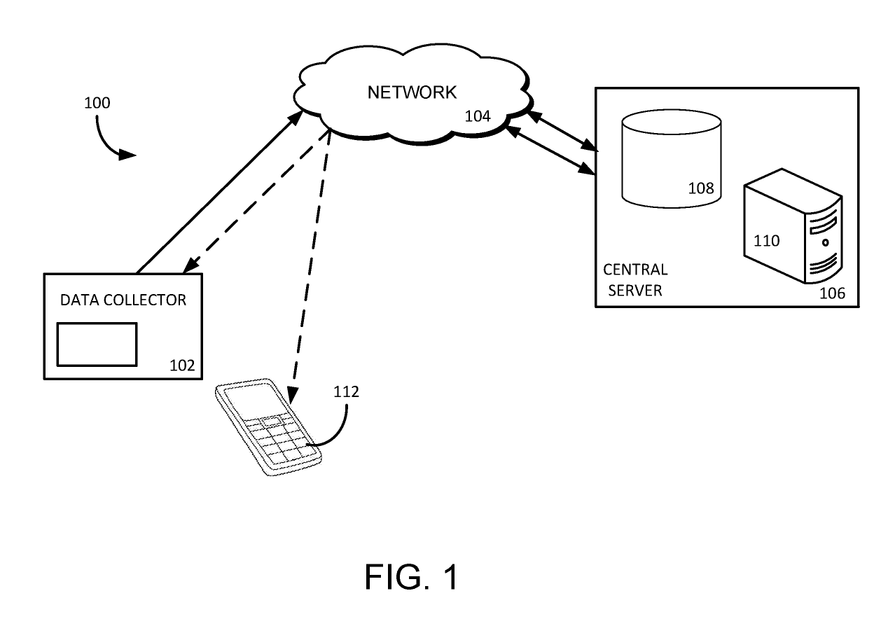

FIG. 1 is a diagram of a system 100 for aggregating environmental data from a data collector 102 or group of data collectors, which data may then be used to determine or adjust a route provided through a navigation device 112. Although illustrated as including certain components, it should be appreciated that the system 100 may include more or fewer components than those illustrated. For example, the network 104 illustrated in FIG. 1 may include any number of networking components, such as routers, servers, switches, and the like. Thus, the system 100 should not be considered to be limited to the components shown. Rather, the components of FIG. 1 are included to simplify the discussion of the operations of the system 100 described below.

In general, the system 100 may include one or more data collectors 102 for detecting and collecting road and/or environmental information. In one particular implementation, the data collector 102 is a vehicle equipped with one or more sensors for detecting a road or other surface condition and/or environmental information in the vicinity of the vehicle. The one or more sensors of the data collector 102 may be any type of sensor for detecting the condition of a road or a condition of an environment around the collector. For example, a vehicle 102 may be equipped with one or more road condition sensors, including but not limited to, wheel speed sensors to detect wheel traction, accelerometers to determine the speed and position of the vehicle, accelerator data, a light detection system to detect a reflectiveness of the road to determine when the road is wet, and the like. In one particular example, the vehicle may include a sensor to detect reflected light from a light projected onto the road surface and compare the detected reflected light to a database of road condition reflectiveness profiles to determine the condition of the road.

In another example, the vehicle 102 may include hazard detection systems to determine potential hazards in the path or near the path of the vehicle. Such hazards may be detected through one or more vision systems, such as an infra-red camera, a Light Detection and Ranging (LIDAR) detector, a Radio Detection and Ranging (RADAR) detector, a millimeter wave camera, stereo imaging sensors, structured light sensors, non-imaging photo-detectors, and the like.

In addition to detecting potential hazards in the road, the one or more vision systems may also be utilized by the vehicle 102 to determine or otherwise collect environmental data around the vehicle. For example, the LIDAR and/or RADAR systems may determine the presence of rain, snow, or standing water around the vehicle or a decreased visibility due to fog around the vehicle. Additional weather-detecting sensors may also be employed, such as temperature or pressure sensors that may provide an indication of the weather conditions around the vehicle. In general, any sensor known or hereafter developed to detect an environmental condition may be utilized by the vehicle. The output from any of the environmental sensors may be compared to one or more stored profiles to determine the type of weather condition detected. For example, the LIDAR may detect rain drops near the vehicle 102 and the pressure sensor may detect a low barometric pressure in a particular area. The vehicle 102 may compare the information received from the LIDAR and the pressure sensor to one or more profiles stored in a database. Upon comparing the information to the profiles, the vehicle 102 may determine a particular weather condition is present in the particular area. In this manner, the information provided by the sensors may be utilized by the vehicle 102 to determine a weather or other environmental condition around the vehicle.

The data collector 102 is in communication with a network 104 and transmits one or more of the collected data to the network. In one particular implementation, the data collector 102 communicates wirelessly with the network 104, although a wired connection may also be utilized. The network 104 may be any type of data network configured to transmit and/or receive data, including a cellular network and a wi-fi network. In one embodiment, the network 104 facilitates the transmission of the collected data 102 to a central server 106. In another embodiment, the central server 106 may form a portion of the network. Regardless of the embodiment utilized, at least a portion of the information collected by the data collector 102 is transmitted to the network for storing at the central server 106.

To facilitate storing of the data from the data collector 102, the central server 106 may include a database 108 or other type of data storage, which may be distributed. Further, as explained in more detail, the central server 106 may receive road and environmental information from several data collectors 102. Further, such information may be aggregated and correlated to the geographic location associated with the information. Thus, the information received at the central server 106 may include a processing component 110 for aggregating the information into an accessible database 108. As also explained in more detail below, the central server 106 may generate a traffic prediction for a particular area based on the received information. Thus, in one implementation, the processing component 110 of the central server 106 may perform this analysis of the received information and generation of the future traffic prediction for one or more geographic areas. It should be appreciated that, although illustrated in FIG. 1 as including the database 108 and the processing device 110, the central server 106 may include any number of components centrally located or spread across the network 104 or other networks. For example, several processing devices 110 and/or databases 108 may be associated with the central server 106 for processing and storing of the received data. Further, a central processing device may be included for coordinating communications between the various components of the central server 106. In one implementation, the central server 106 includes enough components to receive and process information from any number of vehicles 102 or other types of data collectors.

Also included in the system 100 of FIG. 1 is a navigation device. The navigation device may be any type of wired or wireless device that receives a starting location and an ending location, or other locations, and calculates or otherwise facilitates obtaining a navigation path between the locations. In one implementation, the navigation device 112 includes GPS functionality for determining a current location of the navigation device. The navigation device 112 may also include mapping software to aid the device in determining the navigation route and provide a visual indicator of the calculated route on a map presented on a display of the device. Further, the navigation device 112 may include some communication capabilities for communicating with the network 104 or a similar telecommunications network, the collector, and/or other collectors. In general, road and environmental information for a particular location may be transmitted to the navigation device 112 over one or more networks for processing by the device. In one example, the navigation device 112 is a cellular phone with mapping and GPS functionality included.

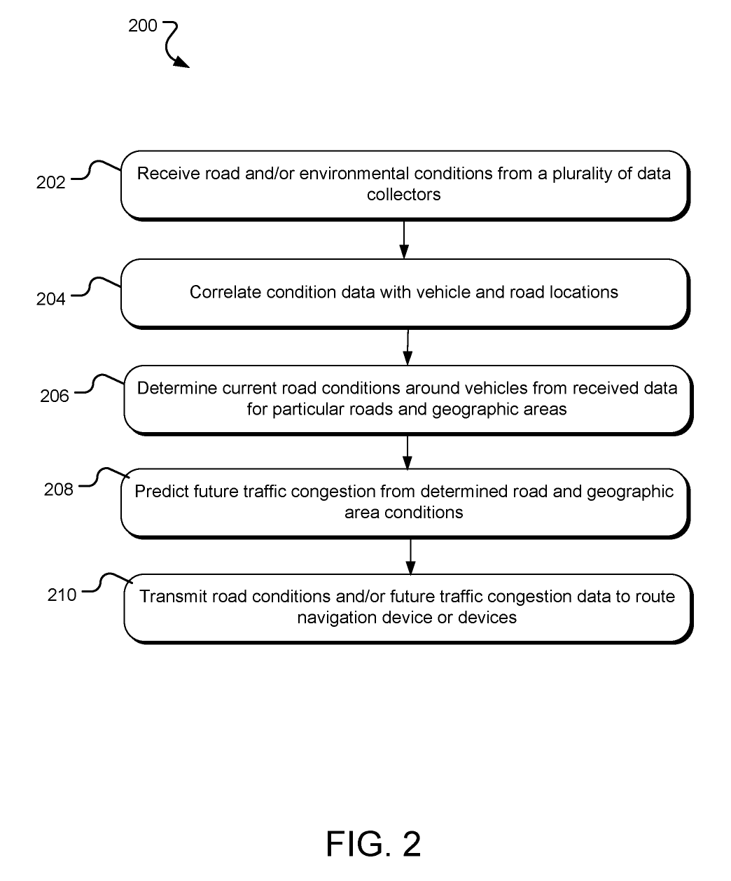

As mentioned above, data collected from the data collector 102 may be transmitted to the central server 106 for storing and processing. In particular, FIG. 2 is a flowchart of a method for aggregating environmental data from a plurality of data collectors and providing the aggregated data to one or more navigation devices. The operations of FIG. 2 may be performed by any components or combination of components of the central server 106 in communication through one or more networks.

Beginning in operation 201, the central server 106 receives road and/or environmental conditions from a plurality of data collectors 102 through a network 104. In particular, as described above, the data collectors 102 obtain road condition information (such as whether the road is wet, icy, snow-covered, any hazards in the road, the general roughness of the road surface, the type of road surface, and the like). In addition, each data collector 102 may obtain environmental information around the data collector, such as the presence of rain, snow, fog, etc. The road and environmental information may be obtained through one or more of the sensors discussed above. Further, the information may be associated with geographic location from which the information was collected and a time stamp that may include day and time the information was obtained by the data collector. The type of information provided to the central server 106 may include the signals collected from the data collector 102 or may be an analysis of the collected data. For example, the information received by the one or more sensors of the data collectors 102 may be directly provided to the central server 106 for analysis to determine an environmental condition around the vehicle. In another implementation, the data collector 102 may determine a general environmental condition for the particular location based on the collected data and transmit the general environmental condition to the central server 106. For example, the data collector 102 may analyse the data and determine that it is rainy in a particular location based on received environmental information from one or more sensors. In response, the data collectors 102 may provide an indication of a rainy condition to the central server 106 for that particular location. Further, a confidence factor may be associated with the analysis of the environmental condition data that indicates the probability of a particular environmental condition based on the obtained data. A higher confidence factor may indicate a higher probability of the accuracy of the analysis.

The collected information may be gathered and stored by the data collector 102 until the data collector is in communication with the network 104 or until an appointed time for uploading the data to the network. In the implementation where the information is transmitted to the network 104 at a designated time, the interval between data upload may vary and/or be set by the network or data collector 102. Regardless, the information is transmitted to the central server 106 through the network 104. Upon receipt, the central server may store the information in one or more databases 108 associated with the central server.

In operation 204, the central server 106 may utilize one or more processing devices 110 to correlate the received information in the database 108. For example, the central server 106 may correlate data received from several data collectors 102 for a one mile stretch along a particular road. Thus, information received from the data collectors 102 that are geographically marked as being collected along that particular mile may be correlated together to obtain an environmental understanding for the particular geographic area. In general, the size of the geographic area may vary and be any size as determined by the central server 106. For example, the central server 106 may correlate received information for a 10 yard portion of the road or may correlate received information for a 10-mile radius around a geographic point.

In addition, the central server 106 may have time thresholds for correlating information for a particular area. For example, condition information may be correlated for the past 5 minutes, one hour, one day, one week, and the like. In general, the central server 106 may establish any time threshold for considering information current and including such information into the correlated condition information for a particular area, as in operation 206 of the method of FIG. 2. Thus, the central server 106 may analyze the time stamp associated with the received information to determine if the information is to be included in the correlated information for the particular geographic location. In one implementation, old or stale data may be discarded by the central server 106. In another implementation, old or stale data may be stored or otherwise maintained by the central server 106 for further analysis of traffic patterns, as discussed in more detail below.

In one particular implementation, several data collecting vehicles 102 may pass over a portion of a particular road and collect road and/or environmental information. This information is tagged with a geographic mark and time stamp. At some later time, the information is transmitted to the central server from the several vehicles. The central server 106 analyzes the information to determine the geographic location and time at which the data was collected by the vehicles 102. Received information that was collected within the same geographic region or area as determined by the central server may be correlated and stored in the database 108 as information from the same location. Further, the information may be sorted based on time of collection and stored accordingly in the database 108, such as current information (the threshold of which is determined by the central server 106) and stale information for the particular geographic area.

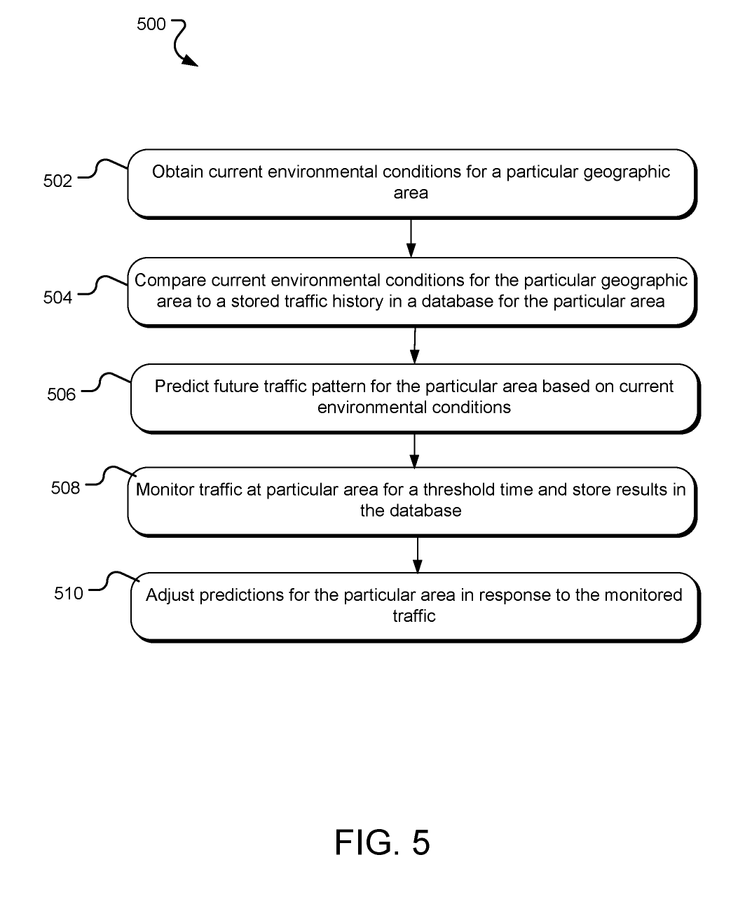

With current road and environmental conditions stored and correlated by the central server 106, the central server 106 may predict future traffic patterns and conditions for one or more geographic locations based on the received condition information in operation 208. For example, through an analysis of past road and environmental information for a particular geographic area or all areas in general, the central server 106 may predict how the currently measured road and environmental conditions may affect the traffic at a particular location. Such a prediction may also consider a day and time for the traffic prediction. In one implementation, the algorithm utilized by the central server 106 to predict a future traffic pattern at a particular location may include machine learning from previous road conditions, environment conditions, and the resulting traffic stored in the database 108 or other storage devices. The prediction of future traffic patterns for a region based on received road and environmental conditions are discussed in more detail below with reference to FIG. 5.

In operation 210, the received road and/or environmental condition information may be transmitted to a navigation device 112 through the network 104 or similar network from the central server 106. In some implementations, the prediction of future traffic for a particular region may also be transmitted to the navigation device 112. Further, the information transmitted to the navigation device 112 may be in response to a request received at the central server 106 from the navigation device. For example, the navigation device 112 may calculate a route from a starting point to a ending point based on user input to the device. In addition to calculating the route, the navigation device may transmit the determined route to the central server 106. In response, the central server 106 may provide past and/or current road and environment conditions for the received route to the navigation device 112. Predicted future traffic conditions for the route may also be provided to the navigation device 112. In one implementation, the navigation device 112 is included in a vehicle that may or may not be a data collector 102 of the system. In another implementation, the central server 106 may receive the start and end points from the navigation device 112 and utilize the road and environment conditions to calculate the route and provide the route, with or without the conditional information, back to the navigation device. In yet another implementation, the navigation device may be an autonomous vehicle and the information may be provided to the vehicle to adjust a route determined by the vehicle to control the operation of the vehicle, including direction and speed of the vehicle. Further, the navigation device 112 and the data collector 102 may be an integrated system such that the data collector utilizes the navigation device to operate the collector. For example, the data collector 102 may be an autonomous vehicle that utilizes the integrated navigation device 112 to operate the vehicle.

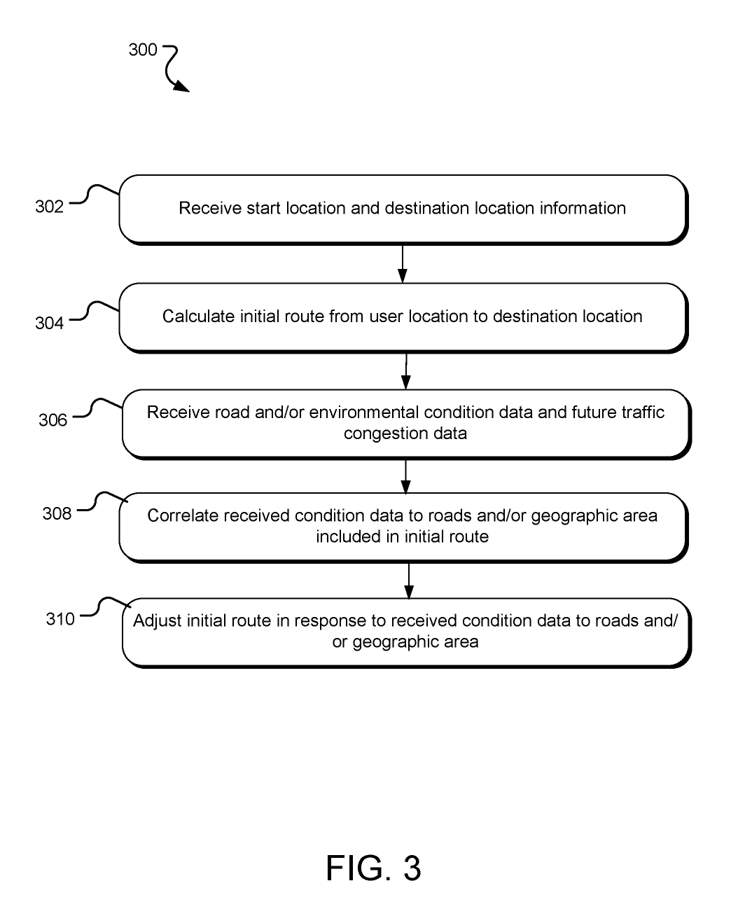

FIG. 3 is a flowchart of a method 300 for determining or adjusting a route in a navigation device based on received environmental data. In general, the operations may be performed by a navigation device 112. The navigation device 112 may be a mobile device (such as a cellular phone), a GPS-based navigation device, an autonomous vehicle, or the like. In general, the navigation device 112 may be any device that determines a route from a starting point to an ending point. In addition, the navigation device 112 may receive additional information in determining a route or adjusting a planned route.

Beginning in operation 302, the navigation device 112 receives a start location and a destination location for a route. In general, the navigation device 112 stores or has access to a map of a region containing the start location and the destination location. With the map information, the navigation device 112 calculates a route between the start location and the end location. In one example, the route includes the streets or roads utilized to reach the destination from the start point, although other components of the map may also be included in the route, such as bike paths, walking paths, sidewalks, pedestrian bridges, etc. Thus, although discussed herein as include a drivable route from the start location to the destination location, any component of a map of a region may be utilized in generating the route.

In one implementation, the start location and the destination location may be provided to the navigation device 112 by a user of the device. For example, the navigation device 112 may include some type of user input component that allows a user of the device to provide an address, a name associated with a location (such as a building, business, amusement park, airport, etc.), or other location identifier to provide the start location and/or the destination location of the route. The navigation device 112 may then determine an associated location within the map region for the start location and destination location. In another implementation of the navigation device 112, the start location may be a GPS-determined location of the device or a user of the device. For example, the navigation device 112 may determine a geographic location of the device utilize GPS. This location may be assumed by the device as a start location for the requested route.

In operation 304, the navigation device 112 calculates an initial route from the start location to the destination location. As mentioned above, the route may include one or more roads a vehicle may traverse along between the two locations. The route may also include other information about the series of steps the vehicle may perform to travel the route, such as which directions the vehicle turns and/or travels (such as “left turn”, “right turn”, “U-turn”, “north”, “south”, etc.), lane information such as which lane the vehicle should be in to perform the next step in the series of steps of the route, localized information of the area around the roads of the route (such as local businesses and services), an estimated time to traverse the initial route, an estimated time of arrival, alternate routes and estimated times to traverse the alternate routes, and the like. Further, in one or more implementations, the navigation device 112 may receive traffic information for roads along the initial and/or alternate routes and utilize the information when estimating the time of arrival. Also, in some implementations, the navigation device 112 may receive one or more user settings to aid in calculating the initial route. For example, a user of the device 112 may prefer to set the shortest route in distance as the initial calculated route. In another example, the user may prefer the shortest route in travel time such that, upon calculating multiple routes from the start location to the destination location, the navigation device 112 provides the quickest route to the user as the initial route. The device 112 may consider current traffic conditions and speed limits of roads when calculating the length of time for traveling various routes.

Regardless of how the initial route is calculated by and provided to the user of the navigation device 112, the device may receive road and/or environmental condition information from the central server 106 in operation 306. As explained above, the road and/or environmental conditions provide some indication of the presence of a weather event in a particular geographic location. For example, the information may indicate that it is currently raining or has recently rained a particular geographic location. In another example, the information may indicate that snow or fog is present in the particular location. In general, the information transmitted to the navigation device 112 by the central server 106 through the network 104 may indicate any weather or road condition for a particular geographic location.

The type of indicator transmitted to the navigation device 112 may be any type of environmental condition information. For example, the information received from the data collectors 102 may be directly provided to the navigation device 112 for processing by the device. In other words, the signals generated by the one or more sensors of the data collectors 102 for a particular geographic location may be transmitted to the navigation device 112 along with the geographic location of the collected data. In another implementation, the central server 106 may determine a general environmental condition for the particular location and transmit the general environmental condition to the navigation device 112. For example, the central server 106 may determine that it is rainy in a particular location based on received environmental information from one or more data collectors 102. In response, the central server 106 may provide an indication of a rainy condition to the navigation device 112 for that particular location. In this manner, the data collector 102, the central server 106, and/or the navigation device 112 may analyse the signals received from the one or more sensors to determine a general environmental condition at a particular location.

Regardless of the type of indicator transmitted, the navigation device 112 correlates the received environmental condition information with a geographic location in operation 308. In particular, the information may be correlated to some portion of the initial route calculated by the navigation device 112. For example, the calculated route may include 10 miles of travel along four different roads, including steps to take to traverse the route. The navigation device 112 may correlate the received environmental information for the portions of the four roads along the 10-mile initial route. The number of correlated information locations with the initial route may depend, in one implementation, on the size of the region associated with the environmental condition information. For example, the environmental condition information may be associated with a small strip of a particular road or may apply for a 10-mile radius. Thus, the received information may be correlated for each strip of road along the route, or a single environmental condition indicator may be applied for the entire route.

Further, the environmental condition indicator or information provided to the navigation device 112 may be based on any criteria, including the initial calculated route. For example, all environmental data or indicators stored by the central server 106 may be provided to the navigation device 112. In another example, the central server 106 may provide a portion of all of the stored environmental condition data, such as the environmental condition data or indicators for a city or other defined geographic region. In these implementations, the navigation device 112 may select or obtain the environmental condition information for the initial route (and in some instances, the one or more alternate routes) from the provided data. In yet another implementation, the navigation device 112 may provide the calculated route to the central server 106. The central server 106, in response, may provide environmental condition data related to the initial route to the navigation route. This implementation may limit the amount of information transmitted to the navigation device 112 to reduce the processing of the information by the device. In still another implementation, the initial route and any other alternative calculated routes may be provided to the central server 106 and the environmental condition information for one or more of the routes may be transmitted to the navigation device 112.

In operation 310, the navigation device 112 may adjust the initial calculated route in response to the received environmental condition information. In general, based on the received environmental condition information for a portion of the initial route, the navigation device 112 may calculate an alternate route between the starting location and the destination location to avoid the region or portion of the route that includes an environmental condition that is detrimental to safe travel. For example, the navigation device 112 may determine that the data indicates that it is raining in a portion of the initial route. In response, the navigation device 112 may determine an alternate route that avoids the rainy portion of the initial route and provide the alternate route to a user of the navigation device. The user may then select the alternate route to avoid the rainy portion. In another implementation, the navigation device 112 may automatically select the alternate route to reroute a vehicle associated with the device around the rainy portion. In yet another implementation discussed in more detail below, the navigation device 112 or central server 106 may predict a traffic pattern based on the received environmental condition data and utilize the information to determine an estimated time of travel for one or more routes. The route with the shortest travel time based on the predicted traffic pattern may then be selected by the navigation device 112 and provided to the user.

In general, current routing methods of navigation devices use travel time only (with some flexibility to avoid highways and tolls). However, through the use of environmental conditions, safety or other cost considerations may also be considered. Environmental conditions such as low visibility, low friction, poor road surface quality and the like, can be incorporated into a cost function for evaluating the total cost to the user of a given route. For example, one implementation of the present disclosure may utilize a cost function for total travel time may be calculated as:

J=sum(1/Vᵢ),

where sum(1/Vᵢ) is a discrete line integral over the inverse of the average velocity for each road segment of a calculated route, Vᵢ. For a simple case in which there are two road sections, one a mile long with an average velocity of 25 mph and another 2 miles long with an average of velocity of 35 mph, this would simply be calculated as 1/25+1/35+1/35=5.8 minutes. An alternate route that offers a faster average velocity will be preferred, as it comes at lower cost, J, regardless of the additional cost to the user.

To incorporate environmental factors into the cost consideration, the cost function in one implementation could be defined as:

J_{eff}=sum(1/(Vᵢ*(1−A)))

where A is a penalty term due to various environmental conditions. For instance, A could penalize low friction surfaces. For example, if during a rain storm, the mean friction value of a given road section is measured to be 0.8 by one of the data collectors 102, then A could be set equal to 0.13. This would reflect the fact that the braking distance from the reduced road friction is roughly equivalent to driving 13% faster. In this way, the effective cost to the user of driving 70 mph on a wet freeway would be equivalent to the cost of driving 61 mph on a dry freeway. As such, the calculated total travel time may be adjusted by the system through a consideration of the environmental factors detected by the data collectors 102.

Of course, the penalty term A may depend on a variety of factors, such as an operator's risk tolerance and the vehicle's tire type (summer vs. all-season, age of the tire, etc.). By incorporating these factors into the cost function of various routes, environmental conditions are thus considered. The cost function expression may also be expanded to incorporate other environmental factors such as visibility (as measured by optical sensors), road surface quality (as measured by vehicle body accelerometers), and road holding (as measured by wheel accelerometers). The selected route based on such a cost function may increase total travel time, but may present the lowest overall cost to the user.

Although described above in reference to adjusting an initial calculated route based on received environmental condition data, one or more of the operations may also be applied to the calculation of the initial route. For example, the navigation device 112 may utilize obtained or requested environmental condition data to calculate the initial route from the starting location to the destination location. In this manner, a current environmental condition of one or more regions between the starting location and the destination location may be considered when calculating the initial route, including the estimated time of travel for any calculated route. Further, the navigation device 112 may include a user preference to avoid regions of the route that include certain types of weather that may be considered by the navigation device when providing routes to the user of the navigation device.

Further, the adjustment to the route by the navigation device 112 may be dependent on the geographic location and type of detected environmental condition. For example, the initial route provided to the navigation device 112 may be several hundred miles depending on the starting and destination locations that may take several hours to traverse by vehicle. In this circumstance, detected environmental conditions near the end of the route may be disregarded by the navigation device 112 and/or the central server 106 for this particular route as such conditions may no longer be present when the vehicle arrives in the region where the environmental condition is detected. Thus, the navigation device 112 may detect the relative speed of the vehicle and provide alternate routing options to a user based on a threshold time value. For example, the navigation device 112 may assume that weather conditions will be stale 30 minutes after being detected. Thus, any portion of the route that will not be traversed by the vehicle in 30 minutes may be disregarded by the navigation device 112. As the vehicle travels, however, the relevant environmental condition data may be adjusted such that geographic regions within the time threshold along the route are considered by the navigation device. In this manner, the navigation device 112 may avoid unnecessary alterations to the initial route for conditions detected far down the calculated route.

Similarly, the navigation device 112 may disregard some information based on the timestamp associated with the environmental condition data. For example, upon correlating the received data with the initial or alternate route, the navigation device 112 may determine the travel time some portions of the route. Based on a timestamp associated with the received information, the navigation device 112 (or central server 106 in some implementations) may determine that the information is or will be stale by the time the vehicle arrives at the portion of the route. In some instances, the information received for the region the vehicle is currently located may be stale and may be disregarded by the navigation device 112.

In another example, a detected environmental condition may cause the system to suggest alternate departure times for a user of the vehicle via a navigation device (in addition to, or in place of, suggesting alternate routes). For instance, if there is detected ice on the roadways of a calculated route for the vehicle but the ambient temperature as detected by the system for the particular area including the icy roads is rapidly increasing, the navigation device routing software may suggest a later departure time to avoid the inclement road conditions. Generally, environmental conditions as measured by data collectors along with the future condition predictions may be incorporated to suggest a different departure time to the user of the vehicle. This could be accomplished with a similar cost function as described above, allowing the penalty term to vary as a function of time. Prediction of conditions of one or more roadways along the calculated route in the future could be predicted by correlating current conditions with past observations or profiles stored by the system.

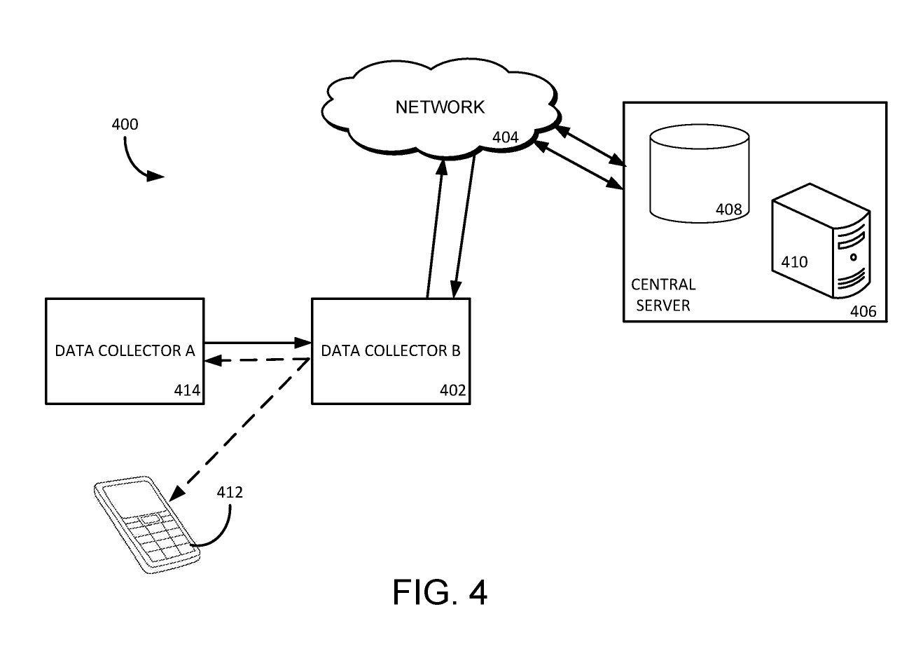

As mentioned above, data collectors 102 may not always be in communication with the network 104 to provide the collected information or environment condition indicator to the central server 106. Thus, in one implementation, the data collectors 102 of the system may communicate with the other data collectors to transmit received and/or collected information. In particular, FIG. 4 is a diagram of a system for collecting and providing environmental data from one data collector 402 to another data collector 414 for aggregating data for a navigation route. The components illustrated in the system 400 of FIG. 4 are similar to those described above with relation to FIG. 1. For example, the system 400 includes a network 404, a central server 406 including a database 408 and processing device 410, and a navigation device 412. In general, the operations and specifics of the components described above may also apply to the components of the system 400 of FIG. 4. In addition, the system 400 includes a first data collector 414 that is not in communication with the network 404 and a second data collector 402 that is in communication with the network. The data collectors 402, 414 of the system 400 are also similar to the data collectors discussed above in function and operation.

Data collector B 402 of the system 400 is in communication with the network 404 to provide collected environmental and/or road condition data or indicators to the central server 406. Further, the central server 406 may collect or receive such data from multiple data collectors to crowd-source the environmental and road condition information. However, in the implementation shown, data collector A 414 may not be in communication with the network 404. For example, data collector A 414 may not be within wireless communication range with the network 404 to provide the collected data. In one implementation, data collector A 414 may store the collected information, along with the geographic location and the timestamp of the information, until the data collector is again in communication with the network 404 and provide the data at that time. In an alternate implementation, data collector A 414 may be in communication with data collector B 402 and may transmit the collected data to data collector B in a similar manner as the data collectors communicate with the network 404. In particular, two or more of the data collectors 402, 414 in the system of environmental data collecting may be in communication with each other to transmit and/or receive information from other data collectors. Upon receiving the data from data collector A 414, data collector B 402 may transmit the information to the network 404 or may store the information until a later time to upload the received information.

In another implementation, data collector A 414 may transmit the data it collects to another data collector in the system, as well as data it receives from another data collector. In this manner, collected information may be passed from one data collector to the next in the system 400, along with data received from other data collectors. Each data collector may determine if a connection to the network 404 is available and transmit the received information to the network and, if no connection to the network is available, to transmit the information to the nearest data collector in the system 400. Thus, the data collected by each of the data collectors in the system 400 may be provided to the central server 406 for aggregation and correlation by the central server.

In a similar manner, the central server 406 may utilize the communication link between the data collectors 402, 414 of the system 400 provide the information to a navigation device 412. For example, environmental condition data or indicators may be provided by the central server 406 to data collector B 402 through the network 404 as described above. In response, data collector B 402 may be configured to transmit the received information to the navigation device 112 for processing and analysis by the navigation device. In addition, the information received from the central server 406 may be transmitted to data collector A 414. In this manner, navigation devices 412 and data collectors 414 of the system that are not in communication with the network 404 may nonetheless receive environmental condition data from the central server 406 for processing as described above.

As mentioned above, the central server 106 may predict future traffic patterns and conditions for one or more geographic locations based on the received condition information. FIG. 5 is a flowchart of a method for predicting a future traffic pattern from one or more road or environmental conditions. The operations of the method 500 may be performed by the central server 106 to predict a traffic pattern at a particular geographic location based on information received concerning the environmental condition of the area from one or more data collectors. This prediction may be provided to a navigation device 112 for use in calculating or adjusting a route for a vehicle.

Beginning in operation 502, the central server 106 obtains current environmental conditions or data for a particular geographic area. In one implementation, this information is collected by one or more data collectors and provided to the central server for processing and/or analysis, as described above. For example, the information may be an indication of an environmental condition, such as rain, snow, fog, etc., at the particular geographic location. In operation 504, the central server may compare the current environmental conditions for the particular geographic area to a stored traffic history in a database for the particular area. For example, the central server 106 may maintain or otherwise have access to a database of stored environmental conditions correlated to geographic locations. One or more of the stored instances of environmental conditions and geographic locations may be associated with an impact to the traffic at that location. Thus, by analyzing the stored conditions, locations, and resulting traffic impact, the central server 106 may determine a likely impact current environmental conditions at the particular location may have on traffic at the location.

For example, the received sensor information from the data collectors may indicate to the central server 106 that it is snowing in a particular geographic area, such as along a portion of a road. The central server 106 may then access the database to determine what impact a snowing event at the geographic area has affected traffic in the past. In one embodiment, the database may store all received information for a geographic location to determine the past traffic impact of a environmental condition. In another embodiment, the database may only store received information for a threshold time such that older information is purged or removed from the database. In this manner, the central server 106 matches a current condition of the area with a similar past condition at the area as stored in the database. Further, the central server 106 may then predict a future traffic pattern at the particular location based on the stored data in operation 506.

The prediction of the future traffic pattern may be based on the monitored effect a similar environmental condition as the current condition had on the traffic. For example, the database may indicate that rain at the particular location caused a delay of 10 minutes for that particular area or region for the next hour. In general, any effect on the traffic pattern of the area may be monitored and stored in the database. From such information, the central server 106 may provide a prediction of a delay of 10 minutes for the next hour at the particular location. This prediction may be transmitted to one or more navigation devices 112 for use when calculating a route for traveling through the region. In addition, the central server 106 may also consider the time of day, the day of the week, the day of the month, and the like when determining the traffic prediction. For example, the central server 106 may limit the past occurrences of traffic obtained from the database to those similar in date and time as the current date and time. For example, the traffic impact at a location due to a rainy condition may be more at rush hour than late at night. In this manner, the prediction may account for the day and/or time of the current condition. In one implementation, a range of similar dates and times may be obtained from the database for reference by the central server 106, the range being determined or set by the central server.

In addition, the traffic prediction mechanism may be further refined through a computer learning process that continues to update and store traffic impact due to environmental conditions. Thus, in operation 508, the central server 106 may monitor the traffic at the particular area for a threshold time and store results in the database. By monitoring the traffic, the central server 106 may determine an impact on the traffic at the current location based on the current conditions at the location. In this manner, the database may be continually updated with the most recent data about traffic at the location due to environmental conditions. Further, in operation 510, the central server 106 may adjust the predictions for a particular region in response to the monitored and stored traffic data. For example, the monitored traffic information may indicate that snow has a particular traffic impact at the area that is less than previously measured. In this example, the predicted impact on traffic at that location by a snowy condition may be lessened, as determined by the central server 106. In this manner, the central server 106 may continue to refine the prediction of the traffic impact at the area to improve the prediction.

In one particular implementation, the machine learning algorithm utilized by the system is based on a simple Bayesian statistics technique. To train the algorithm, vehicle velocity statistics can be gathered from vehicles and/or other mobile devices that are registered or form a portion of the system. As described above, data collectors capable of measuring detailed environmental conditions, such as weather, road friction, visibility, etc, are used to sample conditions along the roadway. A multi-parameter model may then be trained, where the input to the model may contain environmental conditions from the data collectors, as well as traffic information (such as vehicle density, number of freeway entrants, etc.). A Bayesian model can be used generate a maximum likelihood velocity for a road section given as prior various environmental and traffic conditions. As an alternative, a regression analysis may be performed, whereby the average velocity (dependent variable) is determined from a linear combination of input parameters, where the weights of the linear combination are trained from past data.

In one embodiment, the sensors of the data collectors 102 may include weather gathering data sensors such that the data collectors become mobile weather stations. For example, the data collectors 102 may include one or more weather sensors to determine atmospheric pressure, relative humidity, wind speed, wind direction, gust, and/or temperature at the location of the data collector. In general, the wind speed and direction may be detected when the data collector 102 is stationary, such as at a stop light or when in traffic. In this manner, the wind sensor may receive indications from the data collector (such as from a speedometer) to determine when the data collector 102 is not in motion to collect the wind speed measurements. Other weather-related data may be collected at any time by the sensors of the data collectors 102. In general, the frequency at which the sensors collect the weather information may vary from embodiment to embodiment. For example, the sensors may be configured to obtain weather data every second, every five minutes, every hour, once a day, etc. as desired by the parameters of the system 100. The weather sensors may be any known or hereafter developed sensors that collect any data related to the environment or weather in the vicinity of the weather sensors.

Similar to that as described above, the weather data collected by the data collectors 102 may be provided to receiving devices, such as a central server 106, mobile devices like navigation devices 112, or other data collectors. Thus, the collected data may be processed by or transmitted within the system 100 in any manner described above. Also similar to above, the collected data may be correlated with a geographical location and a time the data is collected, such as obtained through a GPS device. In one particular embodiment, the geographical location includes an indication of the altitude of the data collector 102 during the collection of the weather data. In this manner, the system 100 may obtain weather-specific information or data for a particular location from several data collectors 102, with such data provided to and processed by the central server 106 of the system. With this information, the system 100 may generate or store a weather profile at ground level for any location in which one or more data collectors have traveled that indicates a current weather condition at the location.

The system may utilize the collected and aggregated ground-level weather data in many ways. For example, such information may be provided or otherwise available to one or more third parties to improve weather prediction in one or more geographic locations. For example, many weather satellites obtain weather information for all layers of the atmosphere down to the surface. However, a more accurate reading is obtained if the satellite has some information concerning the weather conditions at each layer. Generally, since the surface is the furthest from the satellite, the conditions at the surface are the most prone to errors as determined by the satellite. To improve the data, surface-level weather conditions may be provided to or combined with the data from the satellites to adjust the satellite readings accordingly. Thus, a third party system may be provided access to the weather information obtained by the data collectors 102 of the system 100 and provided to the central server 106. This information may aid the third party systems in improving weather data obtained from satellites or other weather sensors. In a similar manner, the information may be provided to one or more weather prediction systems. This information may replace or supplement existing ground-level weather stations to improve weather predictions made by third party systems. Through the collection and aggregation of the many mobile weather stations 102 of the system 100, weather data collection, weather reporting, and/or weather prediction conducted by a third party may be improved when access to the collected weather data is provided.

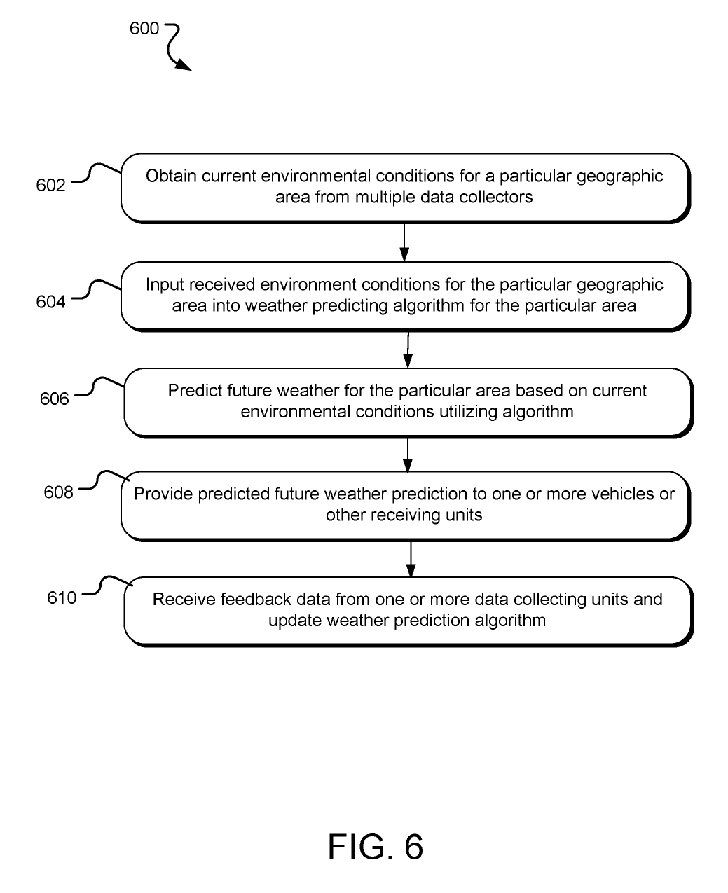

In a similar manner, the system 100 itself may utilize the collected or detected weather information from the weather sensors to predict a weather condition at a particular location. For example, FIG. 6 is a flowchart of a method 600 for predicting a weather condition from weather data collected from multiple data collectors. In general, environmental information is obtained from one or more weather sensors associated with multiple data collectors. This information may be combined, analyzed, and/or processed to determine a current environmental or weather condition at a particular geographic location. Further, the weather information may be provided to a weather predicting algorithm to predict a weather condition at the particular location. In one embodiment, the systems described above with relation to FIGS. 1 and 4 may be utilized to perform the operations of the method 600 of FIG. 6.

Beginning in operation 602, current environmental information and/or data is obtained for a particular geographic location from one or more data collectors. In particular, data collectors may include one or more sensors that detect a weather condition at any one time, as described above. Such environmental data obtained by the data collectors may include, but are not limited to, atmospheric pressure, relative humidity, wind speed, wind direction, gust, and/or temperature at the location of the data collector. In one particular embodiment, the data collector may be a vehicle, such as an autonomous vehicle. Further, the geographic location for which weather data is collected may be any size. For example, the geographic location may be limited to a particular area along a roadway, or may include an entire city.

In operation 604, the received environmental or weather data for the particular geographic area is provided to a weather prediction algorithm and, in operation 606, the algorithm provides a predicted future weather condition at the particular geographic area based on the current weather conditions. In general, the weather prediction algorithm may receive weather-related data or information and process such data to predict a particular weather condition for a geographic area. For example, the weather prediction algorithm may provide a probability percentage for a weather condition, such as snow, rain, clear skies, etc. In another example, the weather prediction algorithm may provide a predicted temperature for the geographic area for some particular time in the future. Those of skill in the art are aware of the various weather prediction algorithms and systems that use collected weather data to provide a predicted weather condition for a geographic area.

In general, the more weather data that an algorithm is provided, the better the prediction of the future weather event becomes. Thus, weather-related data may be collected from multiple data collectors and combined for a particular geographic area. For example, multiple data collectors 102 may collect weather-related data and provide the data to the central server 106. As mentioned, the geographic area from which the weather-related data is obtained may be of any size. As such, the weather-related data may be obtained from multiple data collectors 102 within the geographic area. As more data collectors are utilized, the weather data may become more granulized to improve the data provided to the central server. In another embodiment, the weather data may be collected by the central server 106 and transmitted to one or more data collectors 102. The data collectors 102 connected to the network 104 may then execute the weather prediction algorithm to predict a weather condition at a particular geographic location.

In operation 608, the system may provide the predicted weather for a particular region to one or more receiving units. For example, the predicted weather information may be provided to one or more GPS units to adjust a route for a vehicle. This information may be utilized to adjust the route for the vehicle as described above. In another example, one or more weather alerts based on the weather data may be generated and transmitted to the receiving units. For example, one embodiment of the weather prediction algorithm may compare the data with historical weather data for that particular geographic region. Deviations from the norm as determined from the historical data may cause one or more alerts of potential weather conditions. For example, a measured ten degree drop in temperature over a particular period of time may indicate a high likelihood of rain in the area based on the weather prediction algorithm. In response, the system 100 may transmit one or more alerts to receiving devices (such as other data collectors 102 or vehicles) that a rain event is possible in the area. These alerts or weather predictions may be targeted to receiving units that are within or near the particular geographic area.

In operation 610, the system 100 may receive feedback weather data from one or more data collectors 102 to further refine the weather prediction algorithm. In particular, the system 100 may utilize the same or other data collectors 102 to continue to receive weather information from the particular area in which a weather prediction was made. This actual weather data may be compared to the predicted weather condition by the system 100 to determine the accuracy of the prediction. In circumstances in which the predicted weather and the measured weather conditions do not match, the weather prediction algorithm may be adjusted in response to the inaccurate prediction. Similarly, the weather prediction algorithm may be adjusted for an accurate prediction to reinforce the calculations made by the algorithm. In this manner, the system 100 may utilize machine-learning aspects to adjust the weather prediction algorithm based on the predicted weather condition and a currently measured weather condition from the data collectors of the system.

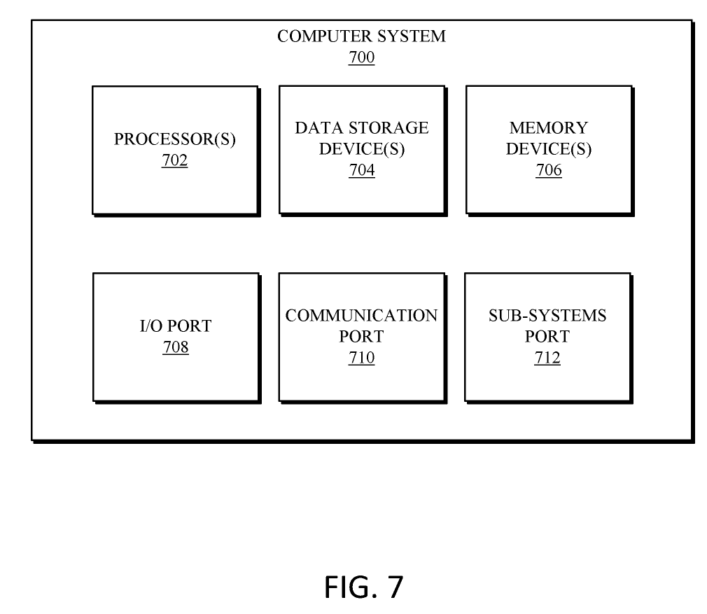

Referring to FIG. 7, a detailed description of an example computing system 700 having one or more computing units that may implement various systems and methods discussed herein is provided. The computing system 700 may be applicable to the central server 106 and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-712, thereby transforming the computer system 700 in FIG. 7 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 710 may communicate with an antenna for electromagnetic signal transmission and/or reception. In some examples, an antenna may be employed to receive Global Positioning System (GPS) data to facilitate determination of a location of a machine, vehicle, or another device.

The computer system 700 may include a sub-systems port 712 for communicating with one or more systems related to a vehicle to control an operation of the vehicle and/or exchange information between the computer system 700 and one or more sub-systems of the vehicle. Examples of such sub-systems of a vehicle, include, without limitation, imaging systems, radar, lidar, motor controllers and systems, battery control, fuel cell or other energy storage systems or controls in the case of such vehicles with hybrid or electric motor systems, autonomous or semi-autonomous processors and controllers, steering systems, brake systems, light systems, navigation systems, environment controls, entertainment systems, and the like.

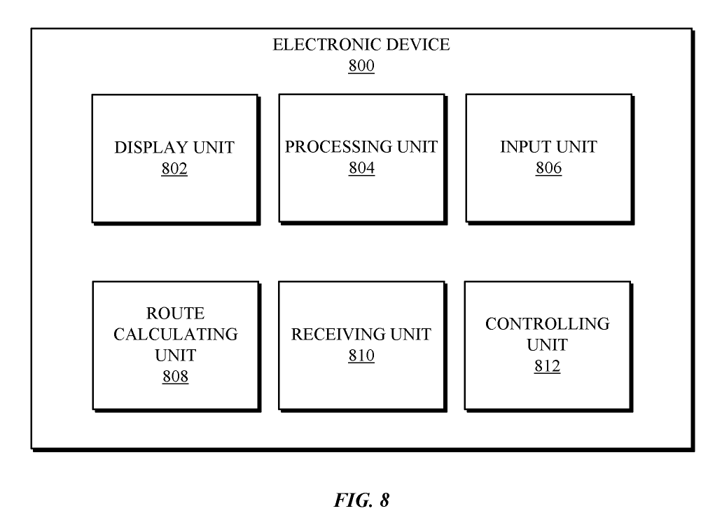

FIG. 8 is a functional block diagram of an electronic device including operational units arranged to perform various operations of the presently disclosed technology. The diagram 800 includes an electronic device 800 including operational units 802-812 arranged to perform various operations of the presently disclosed technology is shown. The operational units 802-812 of the device 800 are implemented by hardware or a combination of hardware and software to carry out the principles of the present disclosure. It will be understood by persons of skill in the art that the operational units 802-812 described in FIG. 8 may be combined or separated into sub-blocks to implement the principles of the present disclosure. Therefore, the description herein supports any possible combination or separation or further definition of the operational units 802-812.

In one implementation, the electronic device 800 includes a display unit 802 configured to display information, such as a graphical user interface, and a processing unit 804 in communication with the display unit 802 and an input unit 806 configured to receive data from one or more input devices or systems. Various operations described herein may be implemented by the processing unit 804 using data received by the input unit 806 to output information for display using the display unit 802.

Additionally, in one implementation, the electronic device 800 includes units implementing the operations described herein. For example, the device 800 may include a calculating unit 808 calculating an initial route for the vehicle from a starting location to a destination location, the initial route comprising at least one road with a surface and calculating an alternate route for the vehicle based at least on the received environmental dataset from the server. A receiving unit 810 receives an environmental data information set, the environmental data information set comprising at least an indication of an environmental condition of a portion of the initial route and wherein the environmental data information set is derived from a plurality of data collectors at or near the at least one road surface. In some implementations, a controlling unit 812 implements various operations for controlling the operation of a vehicle based on the operations implemented by the system.

Although discussed above as methods described by the flowcharts of FIGS. 2, 3, and 5, it should be appreciated that one or more operations may be omitted from the methods discussed. For example, the central server 106 may or may not provide a prediction of traffic impact due to the measured environmental condition. Further, the operations may be performed in any order and do not necessarily imply an order as provided. Rather, the methods discussed are merely one embodiment of the present disclosure as contemplated.

The present disclosure recognizes that the use of data may be used to the benefit of users. For example, the location information of a vehicle may be used to provide targeted information concerning a “best” path or route to the vehicle. Accordingly, use of such location data enables calculated control of an autonomous vehicle. Further, other uses for location data that benefit a user of the vehicle are also contemplated by the present disclosure.

Users can selectively block use of, or access to, personal data. A system incorporating some or all of the technologies described herein can include hardware and/or software that prevents or blocks access to such personal data. For example, the system can allow users to “opt in” or “opt out” of participation in the collection of personal data or portions of portions thereof. Also, users can select not to provide location information, or permit provision of general location information (e.g., a geographic region or zone), but not precise location information.

Entities responsible for the collection, analysis, disclosure, transfer, storage, or other use of such personal data should comply with established privacy policies and/or practices. Such entities should safeguard and secure access to such personal data and ensure that others with access to the personal data also comply. Such entities should implement privacy policies and practices that meet or exceed industry or governmental requirements for maintaining the privacy and security of personal data. For example, an entity should collect users' personal data for legitimate and reasonable uses, and not share or sell the data outside of those legitimate uses. Such collection should occur only after receiving the users' informed consent. Furthermore, third parties can evaluate these entities to certify their adherence to established privacy policies and practices

Embodiments of the present disclosure include various operations or steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method for providing navigation information to a vehicle, the method comprising:
receiving a plurality of environmental data information sets from a plurality of vehicles, each of the plurality of vehicles including a vision sensor system obtaining a corresponding environmental data information set, wherein the plurality of environmental data information sets each comprise a plurality of road surface condition indicators of a corresponding geographic location;
associating a subset of the environmental data information sets to a particular geographic location;
determining an environmental condition at the particular geographic location based at least on the subset of environmental data information sets received from the plurality of vehicles; and
transmitting the environmental condition at the particular geographic location to at least one navigation device, the navigation device associated with the vehicle.

2. The method of claim 1 further comprising:
providing the plurality of environmental data information sets from the plurality of vehicles to a traffic model; and
predicting a future traffic congestion factor at the particular geographic location based on the provided plurality of environmental data information sets from the plurality of vehicles.

3. The method of claim 2 further comprising:
transmitting the predicted future traffic congestion factor at the particular geographic location to the at least one navigation device.

4. The method of claim 1 wherein the plurality of environmental data information sets further comprises indications of visibility at the different geographic locations.

5. The method of claim 1 wherein the plurality of environmental data information set further comprises indications of the presence of precipitation at the different geographic locations.

6. The method of claim 3 further comprising:
monitoring a traffic condition at the particular geographic location for a duration after the predicted future traffic congestion factor at the particular geographic location is transmitted to the at least one navigation device; and
storing the monitored traffic condition at the particular geographic location in a traffic model database.

7. The method of claim 1 wherein the environmental condition at the particular geographic location comprises at least one of a slippery road surface, a dry road surface, a snowing condition, a raining condition, a foggy condition, or a presence of standing water.

8. The method of claim 1 wherein the at least one navigation device comprises a control system of an autonomous vehicle and a route from a starting location to a destination location comprising a travel path to be followed by the autonomous vehicle.

9. The method of claim 1 wherein the plurality of environmental data information sets is obtained through one or more sensors, the one or more sensors including at least one of a light detecting sensor, a temperature sensor, a visual imaging sensor, or a barometric pressure sensor.

10. A method for operating a vehicle, the method comprising:
calculating, utilizing a navigation device, an initial route for an autonomous vehicle from a starting location to a destination location, the initial route comprising at least one road with a surface at a particular geographic location;
receiving an environmental data information set, the environmental data information set comprising at least an indication of an environmental condition of a portion of the initial route and wherein the environmental data information set is indicative of at least one environmental condition at or near the particular geographic location;
calculating, using the navigation device, an alternate route for the autonomous vehicle based at least on the received environmental dataset; and
automatically controlling the autonomous vehicle along the alternate route.

11. The method of claim 10 further comprising:
obtaining, from one or more sensors, a measurement of an environmental condition; and
associating the environmental condition to a particular geographic location and a timestamp corresponding to obtaining the measurement of the environmental condition.

12. The method of claim 11 further comprising:
transmitting the associated measurement of the environmental condition to a transmission vehicle different than the autonomous vehicle.

13. The method of claim 10 further comprising:
receiving a future traffic congestion factor for the at least one road and wherein calculating the alternate route for the vehicle is further based on the future traffic congestion factor for the at least one road.

14. The method of claim 10 wherein the environmental condition indicates at least one of a slippery road surface, a dry road surface, a snowing condition, a raining condition, a foggy condition, or a presence of standing water at the road surface.

15. A system for providing environmental data to a vehicle, the system comprising:
a processing device in communication with a network and receiving a plurality of environmental datasets from a plurality of vehicles, each of the plurality of vehicles including a vision sensor system obtaining a corresponding environmental dataset, wherein a subset of the plurality of environmental datasets comprises at least an indication of an environmental condition at a particular geographic location; and
a memory device for storing the plurality of environmental datasets from the plurality of vehicles;
wherein the processing device executes one or more instructions that cause the processing device to perform the operations of:
associating the subset of the plurality of environmental datasets from the plurality of vehicles with the particular geographic location;
determining an environmental condition at the particular geographic location based at least on the subset of the plurality of environmental datasets received from the plurality of vehicles, and
transmitting the environmental condition at the particular geographic location to at least one navigation device associated with the vehicle, wherein the navigation device calculates a route from a starting location to a destination location of the vehicle based at least on the transmitted environmental condition at the particular geographic location.

16. The system of claim 15 wherein the instructions further cause the processing device to:
provide the plurality of environmental datasets from the plurality of vehicles to a traffic model; and
predict a future traffic congestion factor at the particular geographic location based on the provided plurality of environmental datasets from the plurality of vehicles.

17. The system of claim 16 wherein the instructions further cause the processing device to transmit the predicted future traffic congestion factor at the particular geographic location to the at least one navigation device.

18. The system of claim 15 wherein the subset of the plurality of environmental datasets further comprises an indication of visibility at the particular geographic location.

19. The system of claim 15 wherein the subset of the plurality of environmental datasets further comprises an indication of precipitation at the particular geographic location.

20. The system of claim 15 wherein the navigation device comprises a control system of an autonomous vehicle and the route from the starting location to the destination location comprises a travel path to be followed by the autonomous vehicle.
